(19) United States
(12) Patent Application Publication
(10) Pub. No.: US 2014/0050215 A1
(43) Pub. Date: Feb. 20, 2014

(54) METHOD AND APPARATUS FOR VIRTUALIZING PRIVATE BRANCH EXCHANGE

(71) Applicant: Yangheon LEE, Anyang-si (KR)

(72) Inventor: Yangheon LEE, Anyang-si (KR)

(21) Appl. No.: 13/964,289

(22) Filed: Aug. 12, 2013

(30) Foreign Application Priority Data
Aug. 20, 2012 (KR) 10-2012-0090794

(51) Int. Cl. H04L 29/08

(52) U.S. Cl. CPC H04L 67/28
USPC 370/352

(57) ABSTRACT

The present invention relates to a method and an apparatus for virtualizing a private branch exchange by unifying resources of the private branch exchange into a virtual server thereby to form an internet-based (cloud) environment and using redistribution of the unified resources. A virtual system includes a virtual server configured to register terminals included in physical local system, which performs management to provide registration and services with terminal equipments included in the physical local system, and to redistribute the registered terminal equipments; and at least one virtual local system formed by redistributing the terminal equipments registered in the virtual server.

### CROSS-REFERENCE TO RELATED APPLICATIONS

The present application claims priority from Korean Patent Application No. 10-2012-0090794 filed on Aug. 20, 2012, the entire subject matter of which is incorporated herein by reference.

### TECHNICAL FIELD

The present disclosure generally relates to a telecommunication system, and more particularly to a method and an apparatus for establishing a virtual private branch exchange by unifying resources of the private branch exchanges in a virtual server for an internet-based (cloud) environment and redistributing the unified resources.

### BACKGROUND

A private branch exchange (PBX) system may connect a plurality of local PBXs to each other in two ways.

First, it may be structured that a central manager (CM) controls all apparatuses included in one or more remote managers (RM), so that a plurality of local systems may be integrated into a massive communication system. FIG. 1 is a diagram showing an illustrative embodiment of the PBX connection system. Referring to FIG. 1, it is a hierarchy structure where a local system A functions as a central manager CM to utilize resources of a local system B and a local system C, which function as remote managers RM1 and RM2, to be operated like a single system. The local system A has information on the local system B and the local system C, whereas the local system B and the local system C does not need to have information on each other.

Second, it may be structured that the local systems are horizontally connected via a network. FIG. 2 is a diagram showing an illustrative embodiment of the PBX connection system. Referring to FIG. 2, the local systems A, B and C are connected via a horizontal network, and the numbers of extensions included in the respective local systems are set to have different bands. In such a structure, it is required that each local system connected via the horizontal network has information on other local systems.

Such PBX connections may be useful to form a single massive system by combining a plurality of local systems. However, it may be impossible to utilize the resources included in each local system by other local systems, or to combine various local systems to redistribute resources according to necessity to construct the other local systems.

The above references are incorporated by reference herein where appropriate for appropriate teachings of additional or alternative details, features and/or technical background.

### SUMMARY

The present disclosure provides some embodiments of a method and an apparatus for establishing a virtual private branch exchange.

In one embodiment, by way of non-limiting example, a virtual system includes a virtual server configured to register terminals included in a physical local system, which performs management to provide registration and services with terminal equipments included in the physical local system, and to redistribute the registered terminal equipments; and at least one virtual local system formed by redistributing the terminal equipments registered in the virtual server.

In another embodiment, by way of non-limiting example, a method for virtualizing a private branch exchange includes registering terminal equipments included in a physical local system in a virtual server; establishing, by the virtual server, at least one virtual local system; and redistributing the terminal equipments registered in the virtual server to the at least one virtual local system.

### BRIEF DESCRIPTION OF THE DRAWINGS

The embodiments will be described in detail with reference to the following drawings in which like reference numerals refer to like elements wherein:

FIG. 1 and FIG. 2 are diagrams showing private branch exchange (PBX) connection systems.

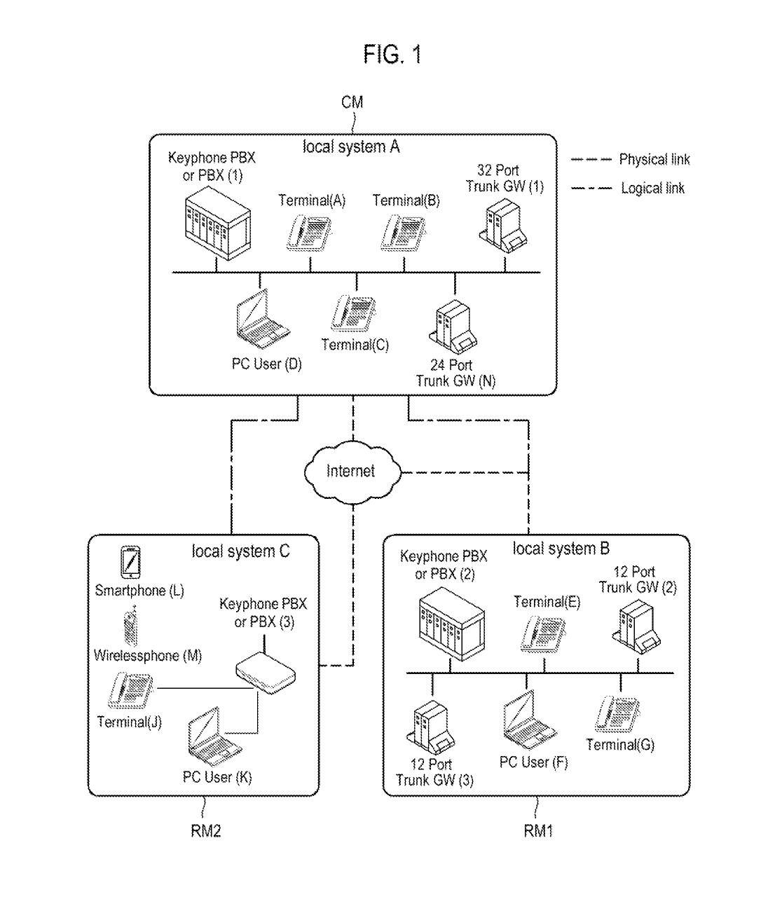

FIG. 3 is a diagram showing an illustrative embodiment of a network environment in which a virtual PBX is established.

FIG. 4 is a block diagram showing an illustrative embodiment of a virtual system.

FIG. 5 is a diagram showing an illustrative embodiment of a physical local system.

FIG. 6 is a diagram showing an illustrative embodiment of a registering process of a terminal or a gateway in a virtual server.

FIG. 7 is a diagram showing an illustrative embodiment of the virtual system in which registration is completed in a virtual server.

FIG. 8 is a diagram showing an illustrative embodiment of the virtual system including terminals redistributed in a virtual local system.

FIG. 9 is a diagram showing an illustrative embodiment of an emergency call process via a virtual server.

FIG. 10 is a diagram showing an illustrative embodiment of an emergency call process via a cloud agent.

FIG. 11 is a diagram showing an illustrative embodiment of a non-emergency call process.

### DETAILED DESCRIPTION

This detailed description is provided with reference to the accompanying drawings. One of ordinary skill in the art may realize that the following description is illustrative only and is not in any way limiting. Other embodiments of the present invention may readily suggest themselves to such skilled persons having the benefit of this disclosure.

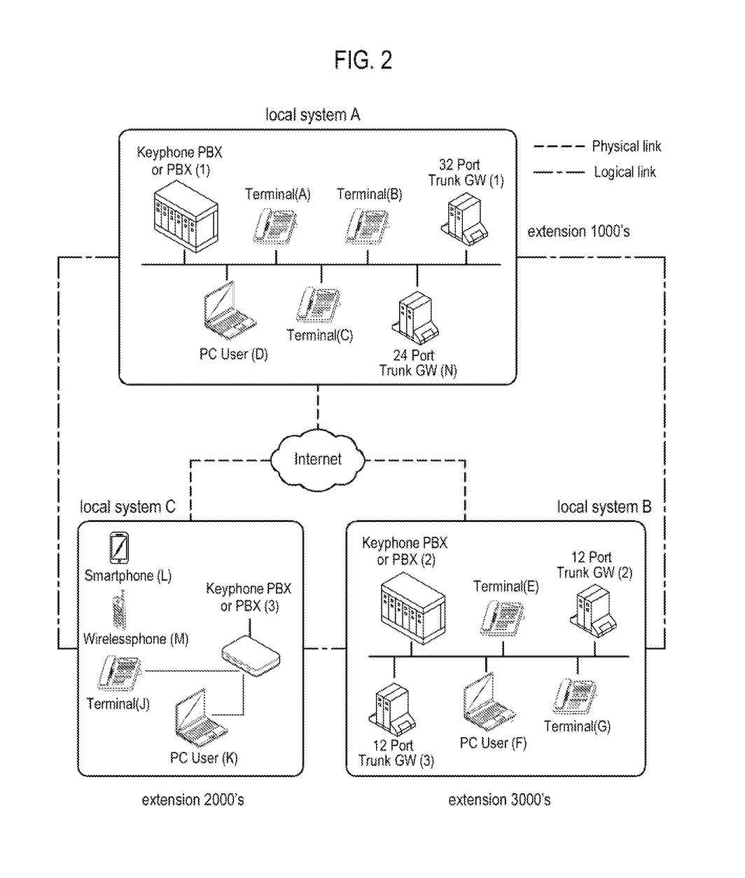

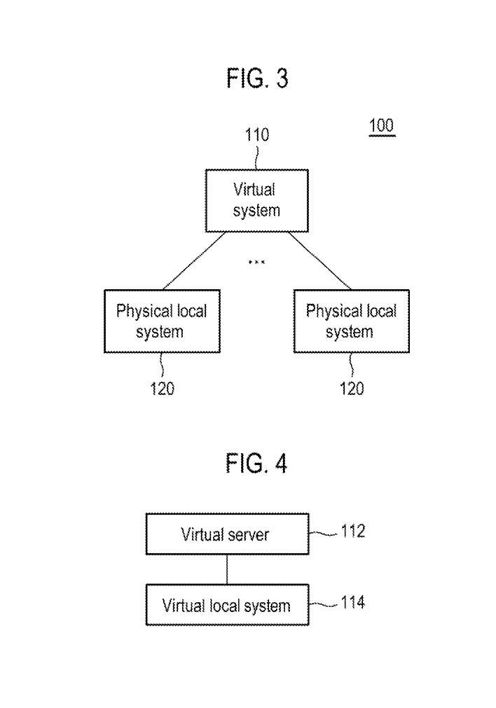

FIG. 3 is a diagram showing an illustrative embodiment of a network environment in which a virtual private branch exchange (PBX) is established and FIG. 4 is a diagram showing an illustrative embodiment of a virtual system.

Referring to FIG. 3 and FIG. 4, the network environment 100 may include a virtual system 110 and at least one physical local system 120. The virtual system 110 may include a virtual server 112 and a virtual local system 114. The physical local system 120 may perform management to register terminals included in the physical local system 120 and to provide services.

The virtual server 112 may be a server for creating and managing the virtual local system 114. The virtual server 112 may perform a setting operation to register terminals such as gateways, keyphone clients and personal computers (PCs) included in the physical local system 120 to the virtual local system for management thereof The virtual server 112 may register the terminals separately into a trunk line and an extension line, and the virtual server 112 may register the terminals separately into a trunk line and an extension line using a port or a plurality of ports through settings in the virtual local system 114. The terminals registered in the virtual server 112 can be registered in the virtual local system 114.

The virtual local system 114 may be established by redistributing the terminals registered in the virtual server 112. The virtual local system 114 may perform functions and operations identical to those of the physical local system 120 except for specific functions such as an emergency call. Specific functions such as an emergency call may be performed through a setup in cloud agent 122 of the physical local system 120 or the PBX 121. A method for making an emergency call will be described later.

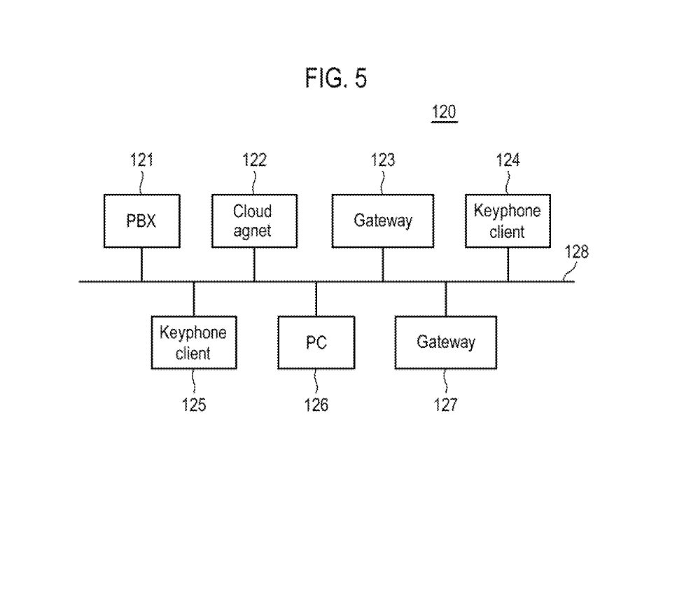

FIG. 5 is a diagram showing an illustrative embodiment of a physical local system.

Referring to FIG. 5, the physical local system 120 may include a PBX 121, a cloud agent 122, one or more gateways 123 and 127, one or more keyphone clients 124 and 125 and at least one PC 126. In one embodiment, the PBX 121, the cloud agent 122, the gateways 123 and 127, the keyphone clients 124 and 125 and the PC 126 may be interconnected with each other via a system bus 128.

The PBX 121 manages the terminals such as the gateways 123 and 127, the keyphone clients 124 and 125, the PC 126 included in the physical local system 120 for registrations and service provisions. When a specific virtual trunk line or a specific virtual extension line is established, the PBX 121 may transmit signals from the corresponding trunk line or the corresponding extension line to the virtual server 112 of the virtual system 110. When the trunk line or the extension line are virtualized, the PBX 121 of the physical local system 120 may not set another function except a virtualizing function.

The cloud agent 122 is a gateway for performing a part of the virtualizing functions when performance of the PBX 121 of the physical local system 120 is insufficient. The cloud agent 122 is configured to exclusively communicate with the virtual system 110. That is, the cloud agent 122 may perform signaling with the virtual system 110 and relay media; check connectivity between the virtual system 110 and the physical local system 120; when the physical local system 120 is disconnected to the virtual system 110, connect the virtual system 110 to a call handling protocol or to the physical local system 120; and perform call handling of the emergency call. In one embodiment, the physical local system 120 may be configured to be not included in the cloud agent 122 and to set the PBX 121 to perform the functions of the cloud agent 122.

The gateways 123 and 127 may represent an apparatus acting as a gate for entrance from one network to the other network. That is, the gateways 123 and 127 may relay networks using different protocols. The gateways 123 and 127 are used when connecting a network such as a local area network (LAN) to other networks. Each network may transmit data by using different protocols from those of other networks. The protocol may represent a set of rules that determine how the data is transmitted. When the networks using other protocols are interconnected directly, the data may not be shared. For example, an e-mail sent via the Internet can be received by using a PC communication service. This is accomplished because a gateway relaying the Internet and a communication network of the PC communication service company exists.

The keyphone clients 124 and 125 may represent terminals connected to a network through the PBX 121 for transmission and reception of the data or messages.

The PC 126 may represent a personal computer. The PC 126 may be connected to the network through the PBX 121 for transmission and reception of the data or the messages.

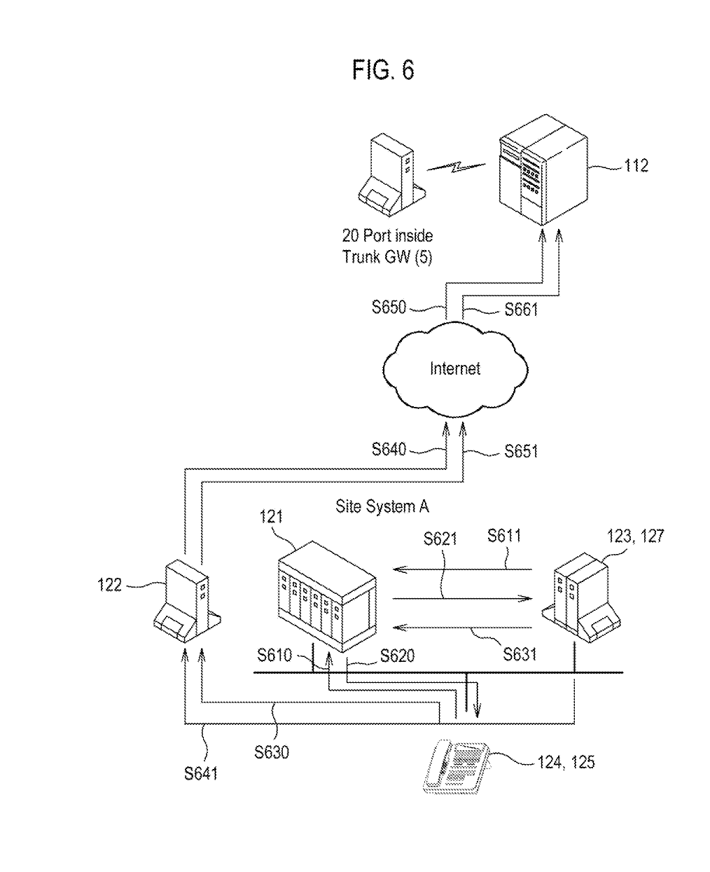

FIG. 6 is a diagram showing an illustrative embodiment of a registering process of the terminal or the gateway in the virtual server.

Referring to FIG. 6, the registering process of the keyphone clients 124 and 125 included in the physical local system 120 in the virtual server 112 will be described below. The keyphone clients 124 and 125 may try to register in the PBX 121 of the physical local system 120 in which the keyphone clients 124 and 125 are initially included, at S610. The PBX 121 may transmit information on addresses of the virtual server 112 and the cloud agent 122 established in the PBX 121 to the keyphone clients 124 and 125, which have tried to register in the PBX 121, at 620. The keyphone clients 124 and 125 may transmit a registration message including information on the address of the virtual server 112 to the cloud agent 122, at 630. The cloud agent 122 may register the registration message of the keyphone clients 124 and 125 in the virtual server 112 via Internet, at S640 and S650. The registering process of the keyphone clients 124 and 125 may not be limited to the above embodiment.

The registering process of the gateways 123 and 127 included in the physical local system 120 in the virtual server 112 is described below. The gateways 123 and 127 may try to register in the PBX 121 of the physical local system 120 in which the gateways 123 and 127 are initially included, at S611. The PBX 121 may transmit information on the addresses of the virtual server 112 and the cloud agent 122 set at the PBX 121 to the gateways 123 and 127, which have tried to register in the PBX 121. Furthermore, the PBX 121 may transmit information on a port used for virtualization to the gateways 123 and 127, which have tried to register in the PBX 121, at S621. The gateways 123 and 127 may register ports not used for virtualization in the PBX 121, at S631. Meanwhile, the gateways 123 and 127 may transmit a registration message including information on the address of the virtual server 112 to the cloud agent 122, at 641. The cloud agent 122 may register the registration message of the gateways 123 and 127 in the virtual server 112, at S651 and S661. The registering process of the gateways 123 and 127 in the virtual server 112 may not be limited to the above embodiment.

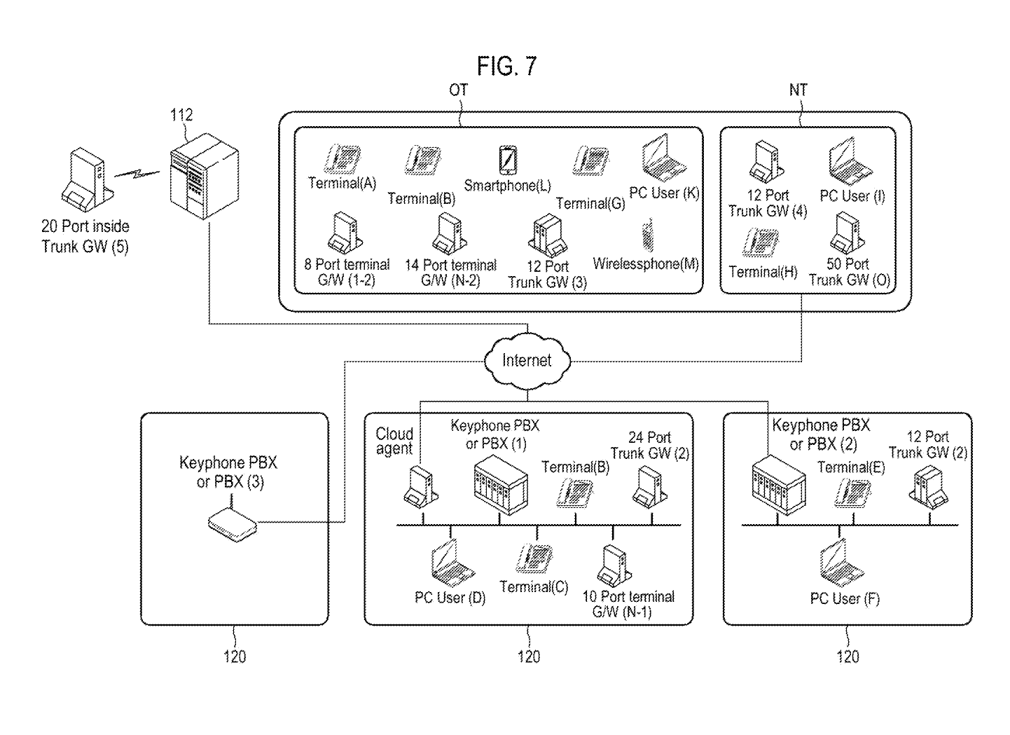

FIG. 7 is a diagram showing an illustrative embodiment of the virtual system in which the registration is completed in the virtual server.

Referring to FIG. 7, the terminals may be classified as terminals only registered in the physical local system 120 and terminals registered in the virtual server 112 through the registering process of the virtual server 112 of FIG. 6. Meanwhile, the virtual server 112 may register terminals NT, which are newly added, in addition to the terminals OT used in the physical local system 120.

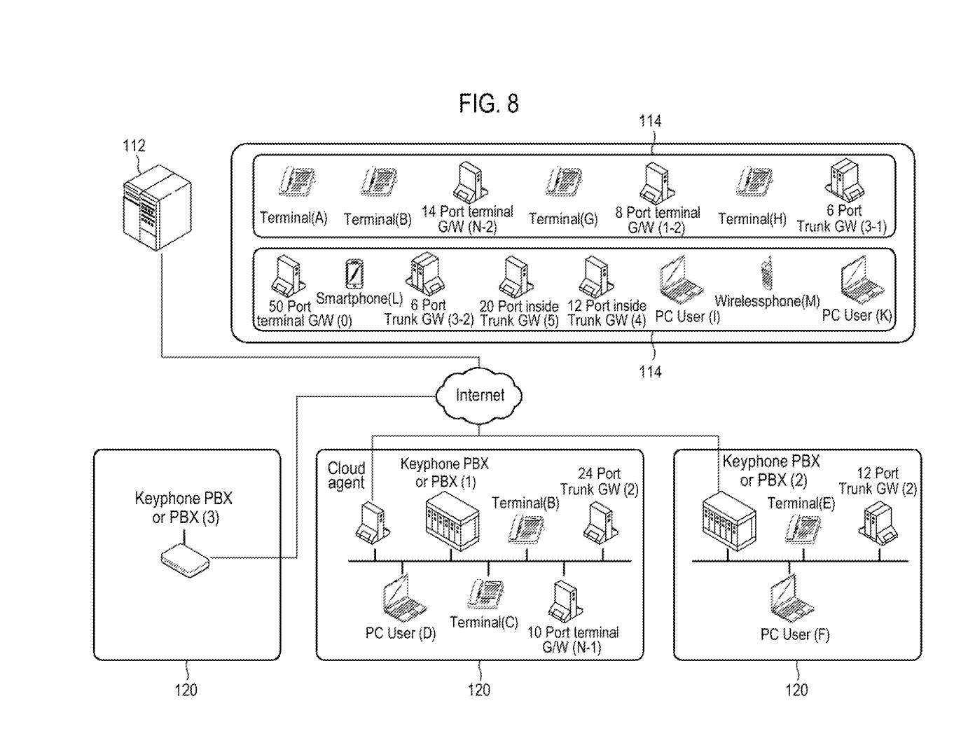

FIG. 8 is a diagram showing an illustrative embodiment of the virtual system including terminals redistributed in the virtual local system.

Referring to FIG. 8, the virtual server 112 may register the terminals, which have been registered in the virtual server 112, as terminals of the physical local system 114 according to setup of the virtual PBX. The terminals registered in the virtual local system 114 may use different network ports or addresses from those used in the physical local system 120 for the respective terminals, or may be serviced by using different network apparatuses from those used in the physical local system 120.

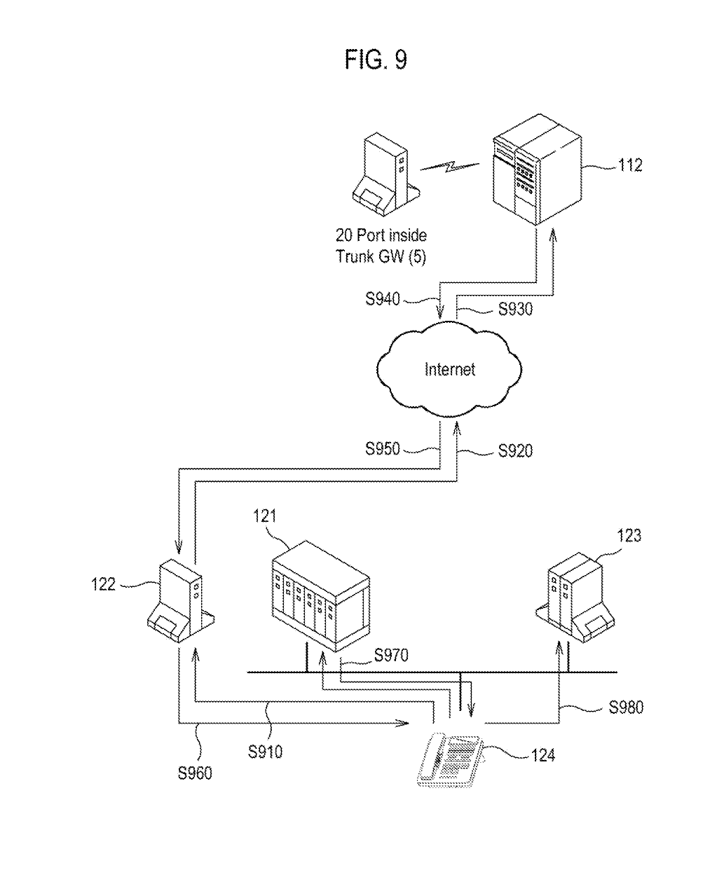

FIG. 9 is a diagram showing an illustrative embodiment of an emergency call process via the virtual server.

Referring to FIG. 9, when the keyphone client 124 included in the virtual local system 114 tries emergency call, a message trying the emergency call may be transmitted to the virtual server 112 through the cloud agent 122, at S910-S930. The virtual server 112 may transmit an emergency call message to the keyphone client 124, which has tried emergency call, at S940-S960. The emergency call message may include information associated with the emergency call, which is inputted through the keyphone client 124 by a user. The PBX 121 receives the emergency call message, which the virtual server 112 has transmitted from the keyphone client 124, allocates the gateway 123, which is not used to be available for emergency call, and transmits information on the allocated gateway 123 to the keyphone client 124, which has tried emergency call, at S970. The keyphone client 124 which received the information on the allocated gateway 123 may perform an emergency call via the gateway 123 based on the information on the allocated gateway 123, at S980.

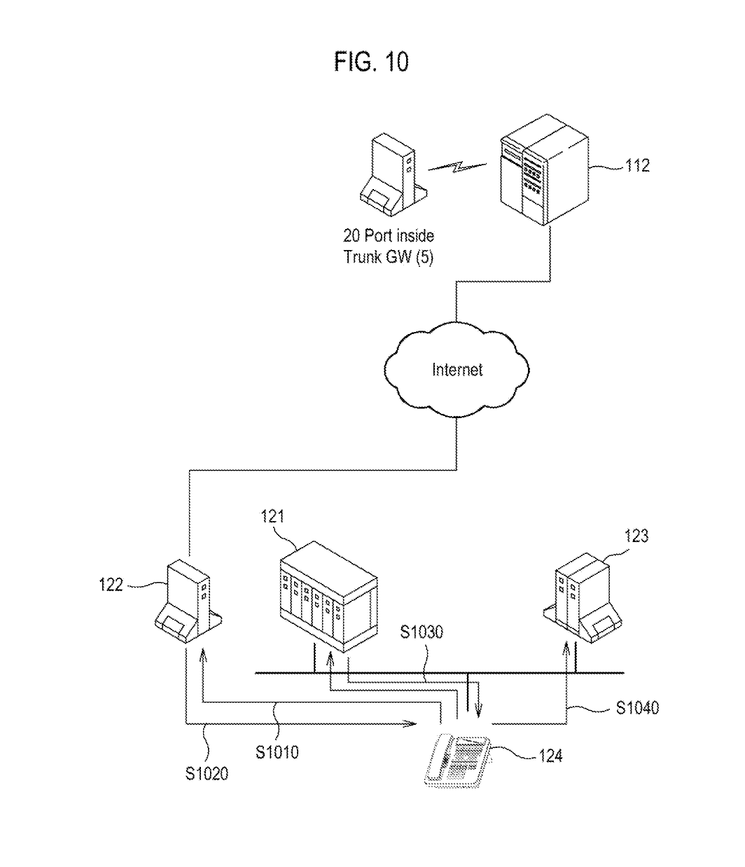

FIG. 10 is a diagram showing an illustrative embodiment of an emergency call process via the cloud agent.

Referring to FIG. 10, the keyphone client 124 may transmit the message trying the emergency call to the virtual server 112 to try the emergency call, at S1010. The PBX 121, which manages the keyphone client 124 trying the emergency call and the cloud agent 122 connecting the virtual server 112 with the keyphone server 124, may monitor messages of the keyphone client 124. The cloud agent 122 may monitor the message trying the emergency call received by the keyphone client 124 to confirm the emergency call, disconnect the connection between the keyphone client 124 and the virtual server 112, and transmit the emergency call message to the keyphone client 124 that tried the emergency call, at S1020. The emergency call message may include information associated with the emergency call, which is inputted through the keyphone client 124 by a user. The PBX 121 receives the emergency call message, which the virtual server 112 has transmitted from the keyphone client 124, allocates the gateway 127, which is not used for emergency calling, and transmits information on the allocated gateway 127 to the keyphone client 124 that tried the emergency call, at S1030. The keyphone client 127, which received the information on the allocated gateway 127, may perform an emergency call by using the gateway 127 based on the information on the allocated gateway 123, at step S1040.

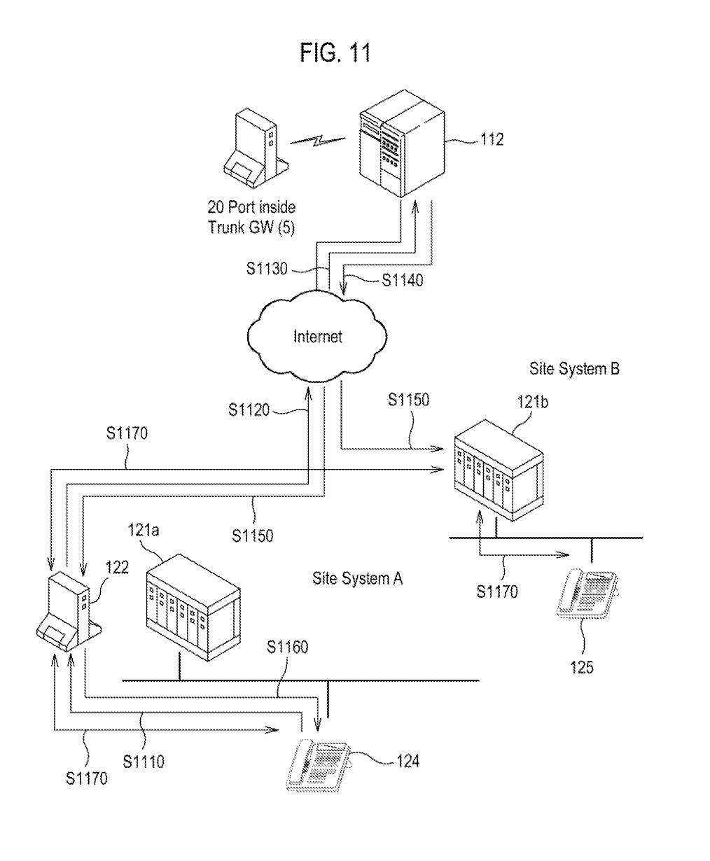

FIG. 11 is a diagram showing an illustrative embodiment of a non-emergency call process.

Referring to FIG. 11, when the user may input a phone number by using the keyphone client 124 to make a call, the keyphone client 124 may transmit the call by trying to message the virtual server 112, at S1110-S1130. The virtual server 112 may transmit a message including information necessary for a call such as port information and the address of the other side keyphone client 125 trying to call to the keyphone client 124 requesting the call and the other side keyphone client 125 trying to call. Because only the PBX 121b registered by the keyphone client 125 may have information on internet protocol IP of the other side keyphone client 125 trying to make a call, the message is transmitted to the keyphone client 125 through the PBX 121b, at S1140-S1160. The keyphone client 124 trying to make a call and the other side keyphone client 125 may set up a call channel and initiate a call by using the message received from the virtual server 112, at step S1170.

According to the present disclosure, resources of the PBX installed at different regions may be utilized effectively, and resources distributed on a small scale may be combined into a single system to thereby form a cloud, so that it is possible to be changed into a massive system regardless of actual capacity of the PBX.

Any reference in this specification to “one embodiment,” “an embodiment,” “example embodiment,” “illustrative embodiment,” etc. means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to affect such feature, structure or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A virtual system, comprising:
a virtual server configured to register terminals included in a physical local system, which performs management to provide registration and services with terminals included in the physical local system, and to redistribute the registered terminals; and
at least one virtual local system formed by redistributing the terminals registered in the virtual server.

2. The virtual system of claim 1, wherein the at least one virtual local system is configured to perform functions and operations identical to functions and operations of the physical local system except an emergency call function.

3. The virtual system of claim 2, wherein the terminals include a private branch exchange.

4. The virtual system of claim 3, wherein the physical system includes:
a cloud agent configured to exclusively communicate with the virtual system;
at least one gateway configured to relay networks using different protocols; and
at least one key phone client connected to a network through the private branch exchange for transmission and reception of data or messages.

5. The virtual system of claim 4, wherein the emergency call function is performed by using the virtual server or the cloud agent.

6. A method for virtualizing a private branch exchange, comprising:
registering terminals included in a physical local system in a virtual server;
establishing, by the virtual server, at least one virtual local system; and
redistributing the terminals registered in the virtual server to the at least one virtual local system.

7. The method of claim 6, wherein the at least one virtual local system is configured to perform functions and operations identical to the physical local system except an emergency call function.

8. The method of claim 7, wherein the emergency call function is performed by using the virtual server or the cloud agent included in the physical local system.
